(19) United States
(12) Patent Application Publication
(10) Pub. No.: US 2025/0352955 A1
(43) Pub. Date: Nov. 20, 2025

(54) PLASMONIC TITANIUM NITRIDE-CONTAINING MIXED MATRIX MEMBRANES AND RELATED MEMBRANE DISTILLATION METHODS

(71) Applicant: Khalifa University of Science and Technology, Abu Dhabi (AE)

(72) Inventors: Faisal Abdulla ALMARZOOQI, Abu Dhabi (AE); Seunghyun HONG, Abu Dhabi (AE); Aya Issa GHAZAL, Abu Dhabi (AE); Alaa SHAHEEN, Abu Dhabi (AE); Sarah Esmaeil ALBLOOSHI, Abu Dhabi (AE); Meera Salem AL MEHRZI, Abu Dhabi (AE)

(21) Appl. No.: 18/665,067

(22) Filed: May 15, 2024

(51) Int. Cl. B01D 69/14; B01D 61/36; B01D 67/00; B01D 69/02; B01D 71/02; B01D 71/34; C02F 1/14; C02F 1/44; C02F 103/00

(52) U.S. Cl. CPC B01D 69/14111; B01D 61/364; B01D 67/00165; B01D 67/00793; B01D 69/02; B01D 69/148; B01D 71/0223; B01D 71/34; C02F 1/14; C02F 1/447; B01D 2313/367; B01D 2323/12; B01D 2323/2181; B01D 2325/02834; B01D 2325/04; B01D 2325/22; B01D 2325/34; B01D 2325/38; C02F 2103/002

(57) ABSTRACT

A mixed matrix membrane that includes polyvinylidene fluoride and TiN nanoparticles may be useful solar-driven surface heating membrane distillation. The plasmonic character of the TiN nanoparticles may locally heat the membrane when exposed to sunlight, which increases the distillation flux across the membrane. Said distillation methods may be particularly useful for treating laundry wastewater to collect distilled water with a reduced concentration of chemical oxygen demand, a reduced concentration of total dissolved solids, and a reduce conductivity. The distilled water may be repurposed for a variety of purposes including agricultural irrigation with significant less impact on the aquatic ecosystem compared to the laundry wastewater.

### BACKGROUND OF THE INVENTION

The rising demand for water resources due to urbanization, industrial growth, and population growth has a significant impact on the pollution of both surface and groundwater. Thus, the treatment of wastewater generated in various sectors is becoming increasingly critical. Most research on wastewater treatment has been devoted to industrial wastewater, while domestic wastewater, despite its significance, has received comparatively less attention. Blackwater and greywater are the two main divisions of domestic wastewater. Black water is the wastewater produced by toilets, while greywater is the wastewater produced by showers, sinks, laundry tubs, washing machines, and kitchen sinks). One main source of domestic grey water is laundry water, accounting for 30% to 40% of the total grey water produced and 5.1% to 18.4% of the total yearly water demand per household.

Laundry wastewater contains relatively high concentrations of chemicals resulting from soap powders, suspended solids, oil, paints, bleach, and other contaminations. Such constituents comprise elevated concentrations of chemical oxygen demand (COD) ranging from 1,200 mg/L to 20,000 mg/L. The COD of wastewater is a measure of the capacity of water to consume oxygen during decomposition of organic matter. The COD provides an indication of the concentration of organic matter in the wastewater that would specifically deplete dissolved oxygen in the water. Domestic laundry wastewater produces effluents with COD ranging from 400 mg/L to 1,200 mg/L. Consequently, discharging such high levels of COD into aquatic environments poses a significant threat to the related ecosystems.

In addition to COD, the concentration of surfactants in wastewater, especially, laundry wastewater, is of particular concern. Surfactants can create a barrier that prevents interaction between water and the gas in the atmosphere, which, at high concentrations, can lower the amount of dissolved oxygen in the water.

To date, diverse methods such as coagulation, floatation, adsorption, biological treatment, and chemical oxidations have been commonly employed to treat laundry wastewater. However, only a small percentage of laundry wastewater has been treated before its release into aquatic environments.

### BRIEF SUMMARY OF THE INVENTION

A nonlimiting example method of the present disclosure comprises: flowing wastewater through a feed side of a membrane distillation module, wherein the feed side is separated from a collection portion of the membrane distillation module by a mixed matrix membrane having a matrix comprising polyvinylidene fluoride (PVDF) with TiN nanoparticles dispersed therein, wherein the mixed matrix membrane has a porosity from 35% to 50%, an average pore size from 250 nm to 550 nm, and a thickness from 0.1 mm to 0.5 mm; exposing the mixed matrix membrane to sunlight while the wastewater is flowing; and distilling water across the mixed matrix membrane.

A nonlimiting example mixed matrix membrane of the present disclosure comprises: a matrix comprising polyvinylidene fluoride (PVDF) with TiN nanoparticles dispersed therein, wherein the mixed matrix membrane has a porosity from 35% to 50%, an average pore size from 250 nm to 550 nm, and a thickness from 0.1 mm to 0.5 mm.

A nonlimiting example solar-driven surface heating membrane distillation system of the present disclosure comprises the foregoing mixed matrix membrane separating a feed side and a collection portion of a membrane distillation module.

A nonlimiting example method of the present disclosure comprises: casting a dope solution onto a membrane support template, the dope solution comprising polyvinylidene fluoride (PVDF), TiN nanoparticles, and a solvent; immersing the cast dope solution on the membrane support template into a coagulation bath comprising a nonsolvent; allowing the cast dope solution to coagulate in the coagulation bath to form a mixed matrix membrane on the membrane support template, the mixed matrix membrane comprising the PVDF with TiN nanoparticles dispersed therein; and separating the mixed matrix membrane from the membrane support template.

### BRIEF DESCRIPTION OF THE DRAWINGS

FIG. 1 illustrates a nonlimiting example of a portion of a solar-driven surface heating membrane distillation system according to at least some embodiments of the present disclosure.

FIG. 2 illustrates a nonlimiting example method for forming a mixed matrix membrane according to at least some embodiments of the present disclosure.

FIGS. 3A-3E are top-down scanning electron microscopy (SEM) images of the fabricated membranes including a control membrane and four mixed matrix membranes according to at least some embodiments of the present disclosure.

FIGS. 3F-3H are cross-sectional SEM images of a mixed matrix membrane according to at least some embodiments of the present disclosure.

FIG. 4 illustrates a bar graph of the porosity of fabricated membranes including mixed matrix membranes according to at least some embodiments of the present disclosure.

FIG. 5 illustrates comparative bar graphs of the pore size for mixed matrix membranes according to at least some embodiments of the present disclosure compared to the control membrane (dashed line bars).

FIG. 6 illustrates a bar graph of the static contact angle of fabricated membranes including mixed matrix membranes according to at least some embodiments of the present disclosure.

FIG. 7 illustrates a bar graph of the thickness of fabricated membranes including mixed matrix membranes according to at least some embodiments of the present disclosure.

FIG. 8 illustrates a bar graph of the liquid entry pressure (LEP) for fabricated membranes including mixed matrix membranes according to at least some embodiments of the present disclosure.

FIG. 9 illustrates a diagram of a surface-heated membrane distillation setup used for testing fabricated membranes including mixed matrix membranes according to at least some embodiments of the present disclosure.

FIG. 10 illustrates a bar graph of the distillation flux (LMH) for fabricated membranes including mixed matrix membranes according to at least some embodiments of the present disclosure.

FIG. 11 illustrates a bar graph of the photothermal efficiency for fabricated membranes including mixed matrix membranes according to at least some embodiments of the present disclosure.

FIG. 12 illustrates a bar graph of the energy demand in a membrane distillation process for fabricated membranes including mixed matrix membranes according to at least some embodiments of the present disclosure.

FIG. 13 illustrates a bar graph of the percent rejection of surfactant for fabricated membranes including mixed matrix membranes according to at least some embodiments of the present disclosure.

FIG. 14 illustrates a bar graph of the percent rejection of chemical oxygen demand for fabricated membranes including mixed matrix membranes according to at least some embodiments of the present disclosure.

FIG. 15 illustrates a bar graph of the thermal conductivity for fabricated membranes including mixed matrix membranes according to at least some embodiments of the present disclosure.

FIG. 16 illustrates a bar graph of the thermal effusivity for fabricated membranes including mixed matrix membranes according to at least some embodiments of the present disclosure.

FIG. 17 illustrates a the surface temperature for fabricated membranes including mixed matrix membranes according to at least some embodiments of the present disclosure over time when exposed to 1250 W/m² light intensity with an inset graph of the average surface temperature for each of the fabricated membranes over the duration of the experiment.

FIG. 18 is a bar graph of the feed solution temperature at the corresponding inlet and outlet of the cell overlaid with the coolant temperature at the corresponding inlet and outlet of the cell during a membrane distillation process for fabricated membranes including mixed matrix membranes according to at least some embodiments of the present disclosure.

FIG. 19 illustrates bar graphs of the performance (distillation flux, photothermal efficiency, and energy demand) for a mixed matrix membrane according to at least some embodiments of the present disclosure in solar-driven surface heating membrane distillation using the real laundry wastewater or the synthetic laundry wastewater.

### DETAILED DESCRIPTION OF THE INVENTION

The present disclosure relates to mixed matrix membranes (MMMs) and related membrane distillation methods suitable for treating wastewater including laundry wastewater. More specifically, the matrix of the MMMs comprises polyvinylidene fluoride (PVDF) with TiN nanoparticles dispersed therein. As used herein, the abbreviation TIN-MMM refers to a MMM having a matrix that comprises PVDF with TiN nanoparticles dispersed therein.

The TiN nanoparticles are plasmonic nanoparticles with a wide bandgap that allows them to efficiently convert the wide spectrum of light from the sun to heat. This is particularly advantageous for solar-driven surface heating membrane distillation (SHMD) methods and systems.

The solar-driven SHMD methods and systems described herein offer a filtration option with low energy requirements and high-performance pollutant rejection. Further, because a large footprint is not required, the related systems may be suitable for not only large volume processing but also individual or home use. Thus, the solar-driven SHMD methods and systems described herein, with reduced reliance on external energy input, has the potential to significantly reduce the cost of clean water production and even facilitate decentralized water treatment when compared to conventional membrane processes.

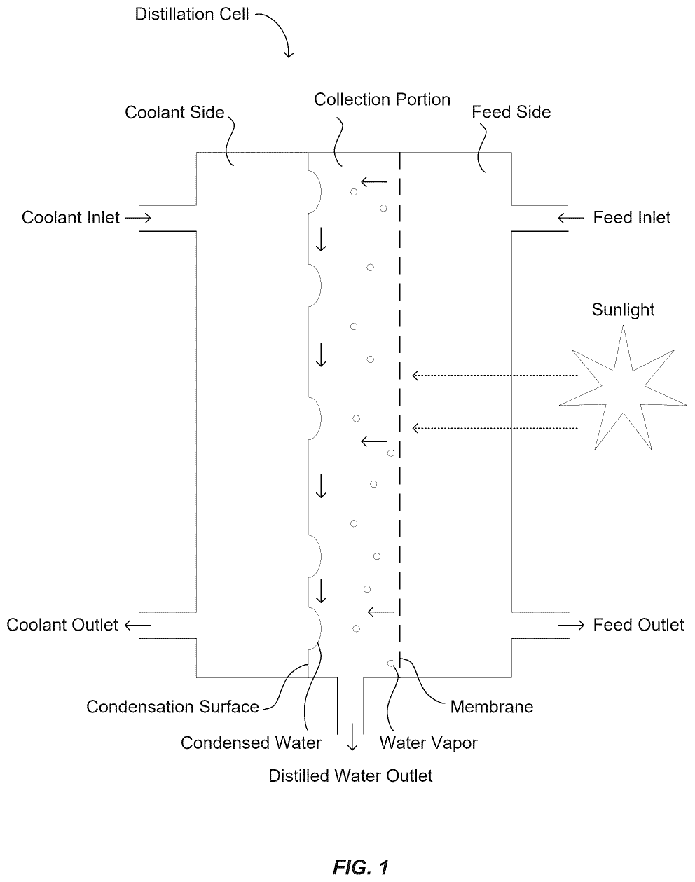

FIG. 1 illustrates a nonlimiting example of a portion of a solar-driven SHMD system. The illustrated distillation cell is partitioned into three portions: a coolant side, a collection portion, and a feed side where the collection portion is between the collection side and the feed side. The coolant side has a coolant inlet and a coolant outlet for circulating coolant through the coolant side. Similarly, the feed side has a feed inlet and a feed outlet for circulating coolant through the coolant side. A condensation surface separates the coolant side and the collection portion, and a membrane separates the feed side and the collection portion. The collection portion also has an outlet for collecting the distilled water. The distillation cell, especially, the feed side, is configured to expose the membrane to sunlight.

In operation, a feed (e.g., wastewater like laundry wastewater) flows through the feed side, and a coolant flows through the coolant side. The temperature of the feed side is higher than the temperature of the coolant side. This creates a vapor pressure difference across the membrane, which facilitates water evaporation at the membrane and flow of the resultant water vapor into the collection portion. The coolant maintains the condensation surface at a sufficiently low temperature to condense the water vapor. In the illustrated example, gravity facilitates collection of the distilled water through the outlet of the collection portion.

The feed temperature and the temperature at the membrane impact the performance of the membrane distillation process. An elevation in the feed temperature at the membrane corresponds to an increase in the vapor pressure difference across the membrane, which leads to an elevated water vapor flux through the membrane to the collection portion. Advantageously, the photonic nature of the TiN nanoparticles in the TIN-MMMs of the present disclosure allow for the sunlight to locally heat the membrane to facilitate a higher vapor pressure difference and improve performance. Consequently, the feed temperature can be at ambient temperature or mildly heated, which reduces the power requirements of the system. For example, for a home system where laundry wastewater flows directly to the solar-driven SHMD system, a feed may be about 45° C. to about 55° C. for a hot water cycle or about 15° C. to about 25° C. for a cold water cycle. In another example, wastewater may be collected from multiple sources before filtration in a solar-driven SHMD system. In this instance, the feed may be ambient temperature or slightly elevated (e.g., if stored in a dark holding tank heated by sunlight before filtration).

The temperature of the feed at the feed inlet may be from about 15° C. to about 55° C. (e.g., 20° C. to 45° C. or 20° C. to 40° C.). The temperature of the coolant at the coolant inlet may be from about 0° C. to about 10° C. (e.g., from 0° C. to 5° C.). Other feed and coolant temperatures outside the foregoing ranges are contemplated.

During operation, the feed flow rate may range from about 5 L/min to about 200 L/min (e.g., 5 L/min to 50 L/min, 25 L/min to 100 L/min, 50 L/min to 150 L/min, or 100 L/min to 200 L/min).

Examples of wastewater feeds may include, but are not limited to, laundry wastewater, kitchen wastewater (e.g., from a sink, dishwasher, etc.), shower wastewater, textile wastewater, oil production plant wastewater, food processing wastewater, agricultural wastewater, chemical manufacturing plant wastewater, paint production facility wastewater, the like, and any combination thereof.

Table 1 provides nonlimiting examples of wastewater compositions that may be used as feeds in the methods and systems of the present disclosure.

TABLE 1
Effluent guidelines for wastewater discharged based the United
States Environmental Protection Agency (EPA) database.

| | | |
|---|---|---|
| | Maximum Average | Average of |
| | of daily | daily values |
| | values for 30 | for 30 |
| Daily | consecutive | consecutive |
| maximum | days | days |

Composition

| | | | |
|---|---|---|---|
| Surfactants, anionic | 0.02 to 1.50 | — | 0.01 to 0.50 |
| (kg/kg) | | | |
| Total phosphorus | 0.03 to 105 | 0.02 to 0.7 | 35 to 35 |
| (as P) (mg/L) | | | |
| Metal, total (mg/L) | 10.5 to 10.5 | — | — |
| Oil & Grease (mg/L) | 10 to 205 | 17 to 50.2 | 5 to 100 |

Properties

| | | | |
|---|---|---|---|
| COD (mg/L) | 200 to 1675 | 86 to 856 | 100 to 630 |
| TDS (mg/L) | 38 to 306 | | 22 to 149 |
| pH | 6.0 to 10.5 | 6 to 10 | 6.0 to 10.5 |

Examples of coolants may include, but are not limited to, water, brine, a mixture of water (or brine) and glycol, the like, and any combination thereof.

The distillation flux of a membrane distillation process using a TiN-MMM of the present disclosure may range from about 0.1 (L/hr/m² also referred to as LMH) to about 0.6 LMH (e.g., 0.2 LMH to 0.6 LMH, 0.3 LMH to 0.6 LMH, or 0.4 LMH to 0.6 LMH). Distillation flux is measured by the volume of distilled water produced over time divided by the area of the membrane through which the water vapor passes. For a 5 cm by 5 cm membrane, only 4 cm by 4 cm of area my participate in distillation because mounting. Accordingly, the area is 15 cm². The area is not the surface area, which would be difference because the membrane is a porous material.

Feeds for solar-driven SHMD methods using the TIN-MMMs of the present disclosure may include one or more of: phosphates, calcium, magnesium, potassium, fats, oil, greases, surfactants, and suspended solids. The resultant distilled water may be characterized by specific properties (e.g., a concentration of a component or a property of the fluid). Additionally, the efficacy of filtration may be characterized by comparing properties of the feed to the properties of the produced distilled water. As used herein, a removal rate for a given property refers to the property in the feed minus the property in the distilled water then divide by the property of the feed reported as a percentage (i.e., multiplied by 100). For example, a sodium ion removal rate for a feed having 100 ppm sodium ions and a resultant distilled water with 3 ppm sodium ions is

$$97 \% = ( 100 ppm - 3 ppm ) / 100 ppm * 100.$$

The distilled water produced by membrane distillation methods (e.g., solar-driven SHMD methods) using the TIN-MMMs of the present disclosure may have a chemical oxygen demand concentration of about 100 mg/L or less (e.g., 0 mg/L to 100 mg/L, 0.1 mg/L to 75 mg/L, 1 mg/L to 65 mg/L, or 5 mg/L to 50 mg/L). The concentration of chemical oxygen demand can be determined using a COD reagent kit (HI93754C-25) by inserting the cuvette in a photometer (HI83399, Multiparameter Photometer with COD, Hanna Instruments).

The membrane distillation methods using the TIN-MMMs of the present disclosure may be characterized by a chemical oxygen demand removal rate of 80% or greater (e.g., 80% to 100%, 85% to 100%, or 90% to 100%).

The distilled water produced by membrane distillation methods using the TIN-MMMs of the present disclosure may have a total dissolved solids concentration of about 0.5 g/L or less (e.g., 0 g/L to 0.5 g/L, 0.01 g/L to 0.3 g/L, or 0.05 g/L to 0.2 g/L). The concentration of total dissolved solid can be determined by ASTM D5907-18.

The membrane distillation methods using the TiN-MMMs of the present disclosure may be characterized by a total dissolved solids removal rate of 90% or greater (e.g., 90% to 100%, 93% to 100%, or 95% to 100%).

The distilled water produced by membrane distillation methods using the TIN-MMMs of the present disclosure may have a conductivity of about 250 μS/cm or less (e.g., 0.5 μS/cm to 250 μS/cm, 1 μS/cm to 200 μS/cm, or 1 μS/cm to 150 μS/cm). The conductivity can be determined by ASTM D1125-23 (at room temperature and ambient pressure).

The membrane distillation methods using the TiN-MMMs of the present disclosure may be characterized by a total dissolved solids removal rate of 90% or greater (e.g., 90% to 100%, 93% to 100%, or 95% to 100%).

The distilled water produced by membrane distillation methods using the TIN-MMMs of the present disclosure may have a pH from about 6.5 to about 7.5 (e.g., 6.5 to 7.2, 6.8 to 7.3, or 7.0 to 7.5).

The distilled water produced by membrane distillation methods using the TiN-MMMs of the present disclosure may have a turbidity of about 1 nephelometric turbidity units (NTU) or less (e.g., 0 NTU to 1 NTU, 0 NTU to 0.5 NTU, or 0 NTU to 0.3 NTU). Turbidity can be measure according to USEPA Method 180.1.

The distilled water produced by membrane distillation methods using the TIN-MMMs of the present disclosure may have a five-day biochemical oxygen demand (BOD5) of about 5 ppm or less (e.g., 3 ppm or less, 1 ppm or less, or 0.5 ppm or less).

The distilled water produced by membrane distillation methods using the TiN-MMMs of the present disclosure may have a dissolved oxygen content from about 3 ppm to about 15 ppm (e.g., 5 ppm to 15 ppm, 7 ppm to 15 ppm, or 8 ppm to 12 ppm).

The distilled water produced by membrane distillation methods using the TiN-MMMs of the present disclosure may have a phosphate content of 40 ppm or less (e.g., 0 ppm to 40 ppm, 0 ppm to 20 ppm, 0 ppm to 10 ppm, or 0 ppm to 2 ppm).

The distilled water produced by membrane distillation methods using the TiN-MMMs of the present disclosure may have a nitrate content of 10 ppm or less (e.g., 0 ppm to 10 ppm, 0 ppm to 7 ppm, 0 ppm to 5 ppm, or 0 ppm to 2 ppm).

The distilled water produced by membrane distillation methods using the TiN-MMMs of the present disclosure may have a nitrite content of 10 ppm or less (e.g., 0 ppm to 1 ppm, 0 ppm to 0.7 ppm, 0 ppm to 0.4 ppm, or 0 ppm to 0.1 ppm).

### TIN-MMM Compositions and Preparation Methods

TiN-MMMs of the present disclosure have a matrix comprising PVDF with TiN nanoparticles dispersed therein.

A weight ratio of the PVDF to the TiN nanoparticles in the TIN-MMMs of the present disclosure may range from about 20:1 to about 1:2 (e.g., 20:1 to 1:1, 10:1 to 1:2, or 4:1 to 1:2).

The PVDF in the TIN-MMMs of the present disclosure may have a weight average molecular weight (Mw) from about 250,000 g/mol to about 1,500,000 g/mol (e.g., 250,000 g/mol to 750,000 g/mol, 500,000 g/mol to 1,000,000 g/mol, or 750,000 g/mol to 1,500,000 g/mol). The Mw can be measured using gel permeation chromatography methods.

The TiN nanoparticles in the TIN-MMMs of the present disclosure may have an average diameter from about 10 nm to about 500 nm (e.g., 10 nm to 150 nm, 100 nm to 250 nm, or 200 nm to 500 nm). Unless otherwise specified, average diameter is a weight average diameter, which can be determined by light scattering methods.

The TiN nanoparticles preferably have a substantially spherical shape where at least 90% of the volume of the smallest sphere encasing the particle is made up of the particle. Alternate shapes may also be suitable. Examples of alternate shapes may include, but are not limited to, rods, stars, and the like. A combination of multiple shapes may be used.

The TiN-MMMs of the present disclosure may be formed by casting a dope that comprises the PVDF and the TiN nanoparticles. A preferred casting method is nonsolvent-induced-phase-separation casting where the dope also includes a solvent.

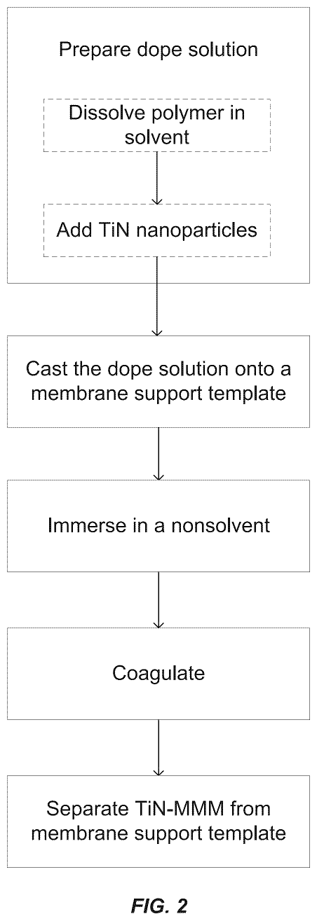

FIG. 2 illustrates a nonlimiting example method for forming a TiN-MMM of the present disclosure. The method includes preparing a dope solution that comprises PVDF, TiN nanoparticles, and a solvent. The solvent can be any suitable solvent for PVDF. Examples of solvents include, but are not limited to, dimethylacetamide (DMAc), dimethylformamide (DMF), dimethyl sulfoxide (DMSO), N-methylpyrrolidone (NMP), the like, and any combination thereof.

The PVDF may be present in the dope solution from about 5 wt % to about 20 wt % (e.g., 5 wt % to 15 wt % or 10 wt % to 20 wt %), based on a total weight of the dope solution. The TiN nanoparticles may be present in the dope solution from about 0.5 wt % to about 20 wt % (e.g., 0.5 wt % to 10 wt %, 5 wt % to 15 wt %, or 10 wt % to 20 wt %), based on a total weight of the dope solution. A weight ratio of the PVDF to the TiN nanoparticles in the dope solution may range from about 20:1 to about 1:2 (e.g., 20:1 to 1:1, 10:1 to 1:2, or 4:1 to 1:2).

Preparation of the dope solution may include first dissolving the PVDF in the solvent then suspending the TiN nanoparticles in the PVDF solution, which is illustrated in FIG. 2. Alternatively, preparation may include adding the PVDF and TiN nanoparticles to the solvent simultaneously and mixing until the PVDF is dissolved. Alternatively, preparation may include adding the PVDF to the solvent, mixing until at least half of the PVDF is solubilized, and then adding TiN nanoparticles. Alternatively, preparation may include adding the TiN nanoparticles to the solvent before the PVDF.

The dope solution is then cast onto a membrane support template. For example, a porous membrane mounted on a support (e.g., glass or metal) can be used as the membrane support template. The porous membrane used for templating may have a pore size ranging from about 250 nm to 1000 nm (e.g., 250 nm to 750 nm). The porous membrane should be made of a material (e.g., polyethylene, polypropylene, and the like) that can be easily separated from the PVDF after coagulation in a later step.

The dope solution can be cast using a knife casting apparatus or other suitable casting apparatus. The dope solution may be cast to a thickness from about 0.2 mm to about 1 mm (e.g., 0.4 mm to 0.8 mm).

Then, the cast dope solution on the membrane support template is immersed in a coagulation bath comprising a nonsolvent. The nonsolvent is not a solvent (e.g., water) for PVDF but is miscible with the solvent in the cast dope solution.

Immersion may be maintained for a sufficient time to allow the cast dope solution to coagulate in the coagulation bath and form a TiN-MMM on the membrane support template. Immersion may be for any suitable amount of time, for example, about 1 minute to about 24 hours or longer.

The TIN-MMM may then be separated from the membrane support template. After coagulation and before and/or after separation from the membrane support template, the TIN-MMM may be washed with a nonsolvent (the same or different than the coagulation bath) to remove any non-coagulated polymer or solvent residuals. Finally, the TIN-MMM may be dried.

The TiN-MMMs of the present disclosure may have a thickness from about 0.1 mm to about 0.5 mm (e.g., 0.1 mm to 0.3 mm or 0.2 mm to 0.5 mm).

The TiN-MMMs of the present disclosure may have a porosity from about 35% to about 50% (e.g., 35% to 45% or 40% to 50%). Porosity can be determined by the gravimetric method. This method involves immersing a membrane sample of known volume using Galwick™ solution (density (ρ_{calwick}) of 1.79 g/cm³ and surface tension (v) of 15.9 dyne/cm). The sample is allowed to soak in the solution for an adequate duration to ensure that most of the pores were infused with this low-surface tension liquid. Thereafter, masses of the samples before (m₁) and after (m₂) were observed to calculate the porosity using below equation.

$$Porosity ( \% ) = \frac{{m}_{2} - {m}_{1}}{v {ρ}_{Galwick}}$$

The TiN-MMMs of the present disclosure may have an average pore size from about 250 nm to about 550 nm (e.g., 250 nm to 450 nm or 350 nm to 550 nm). Average pore size can be determined by Brunauer-Emmett-Teller (BET) surface area and Barrett, Joyner, and Halenda (BJH) pore size distribution analysis using surface area and pore size analyzer, NOVA 2000e.

The TIN-MMMs of the present disclosure may have a contact angle with deionized water (at room temperature and ambient pressure) from about 90° to about 100° (e.g., 90° to 97° or 93° to) 100°. Contact angle can be determined by wettability test to observe the hydrophobicity or hydrophilicity of the membrane samples using contact angle equipment (Kruss Goniometer, DSA25) with a micro syringe attached to it. The measurement was based on the sessile drop method. In the sessile drop method, a small droplet of water is placed on the membrane surface, and the contact angle is measured where the droplet meets the surface. A drop size of 5 μL was fixed for all the measurements.

The TiN-MMMs of the present disclosure may have a tensile stress from about 15 MPa to about 35 MPa (e.g., 15 MPa to 30 MPa or 20 MPa to 35 MPa). Tensile stress can be determined by universal tensile testing equipment (Instron Materials Testing, IMT 5900 series, MA). For tensile strength measurements, the sample size was 10×64 mm2, a stretching rate of 0.05 mm/sec, and a distance between two clamps of 25 mm.

The TIN-MMMs of the present disclosure may have an elongation strain (elongation-to-break) from about 17% to about 30% (e.g., 17% to 25% or 20% to 30%). Elongation strain can be determined by ASTM D638-14.

The TiN-MMMs of the present disclosure may have a photothermal efficiency from about 10% to about 35% (e.g., 10% to 25% or 20% to 35%). Photothermal efficiency (n) can be determined by dividing the actual flux obtained in each experiment over the maximum theoretical flux as demonstrated in the below equation.

$$η ( \% ) = \frac{Actual Flux}{Maximum theoretical Flux}$$

The TiN-MMMs of the present disclosure may have a liquid entry pressure (LEP) from about 1.5 bar to about 2 bar (e.g., 1.5 bar to 1.8 bar or 1.7 bar to 2.0 bar). Liquid entry pressure can be determined by a liquid entry pressure analyzer (Convergence Inspector). LEP is influenced by a variety of factors, including the maximum pore size of the membrane, the surface tension of the liquid, the contact angle of the liquid on the membrane surface, and the geometrical structure of the membrane. In general, a higher LEP indicates that the membrane is more resistant to wetting, which facilitates higher evaporative pressure and fluxes.

The TiN-MMMs of the present disclosure may have a thermal conductivity from about 4 W/m-K to about 12 W/m-K (e.g., 4 W/m-K to 9 W/m-K or 7 W/m-K to 12 W/m-K). Thermal conductivity can be determined by a hot disk thermal analyzer (TPS 2500 S, Gothenburg). Under a heating power of 0.14458 W, two samples (˜ 40 mm diameter) for each fabricated membrane were tested for 20 sec.

The TiN-MMMs of the present disclosure may have a thermal effusivity from about 8 kWs^{1/2}/m²-K to about 12 kWs^{1/2}/m²-K (e.g., 8 kWs^{1/2}/m²-K to 11 kWs^{1/2}/m²-K or 10 kWs^{1/2}/m²-K to 12 kWs^{1/2}/m²-K). Thermal effusivity can be determined by a hot disk thermal analyzer (TPS 2500 S, Gothenburg). Under a heating power of 0.14458 W, two samples (˜40 mm diameter) for each fabricated membrane were tested for 20 sec.

The thermal conductivity and effusivity of membranes provide an indication of the photothermal efficiency and evaporative effects across the TIN-MMM surface. For example, high thermal effusivity by the membrane surface can be detrimental because it facilitates rapid heat exchange with surrounding fluids. This can be disadvantageous during the distillation operation, where effective heat retention and utilization are crucial. On the other hand, a lower thermal effusivity is preferable as it promotes heat retention and heat utilization throughout the distillation operation.

### Nonlimiting Aspects of the Disclosure

Aspect 1. A method comprising: flowing wastewater through a feed side of a membrane distillation module, wherein the feed side is separated from a collection portion of the membrane distillation module by a mixed matrix membrane having a matrix comprising polyvinylidene fluoride (PVDF) with TiN nanoparticles dispersed therein, wherein the mixed matrix membrane has a porosity from 35% to 50%, an average pore size from 250 nm to 550 nm, and a thickness from 0.1 mm to 0.5 mm; exposing the mixed matrix membrane to sunlight while the wastewater is flowing; and distilling water across the mixed matrix membrane.

Aspect 2. The method of claim 1, wherein the wastewater is laundry wastewater.

Aspect 3. The method of claim 1 or 2, wherein the distilled water compared to the wastewater has a chemical oxygen demand removal rate of 80% or greater, a total dissolved solids removal rate of 90% or greater, and a conductivity removal rate of 90% or greater.

Aspect 4. The method of any one of claims 1-3, wherein the distilling is characterized by a distillation flux from 0.1 LMH to 0.6 LMH.

Aspect 5. The method of any one of claims 1-4, wherein the mixed matrix membrane has a photothermal efficiency from 10% to 35%.

Aspect 6. The method of any one of claims 1-5, wherein the wastewater has a temperature at an inlet of the feed side from 20° C. to 45° C.

Aspect 7. The method of any one of claims 1-6, wherein a coolant flowing through a coolant side of the membrane distillation module has a temperature at an inlet of the coolant side from 0° C. to 10° C.

Aspect 8. The method of any one of claims 1-7 further comprising: using the distilled water for agricultural irrigation.

Aspect 9. A mixed matrix membrane comprising: a matrix comprising polyvinylidene fluoride (PVDF) with TiN nanoparticles dispersed therein, wherein the mixed matrix membrane has a porosity from 35% to 50%, an average pore size from 250 nm to 550 nm, and a thickness from 0.1 mm to 0.5 mm.

Aspect 10. The mixed matrix membrane of claim 9, wherein a weight ratio of the polyvinylidene fluoride to the TiN nanoparticles is 20:1 to 1:2.

Aspect 11. The mixed matrix membrane of claim 9 or 10, wherein the mixed matrix membrane has a contact angle with deionized water from 90° to 100°.

Aspect 12. The mixed matrix membrane of any one of claims 9-11, wherein the mixed matrix membrane has a liquid entry pressure from 1.5 bar to 2 bar.

Aspect 13. The mixed matrix membrane of any one of claims 9-12, wherein the mixed matrix membrane has a thermal conductivity from 4 W/m-K to 12 W/m-K.

Aspect 14. The mixed matrix membrane of any one of claims 9-13, wherein the mixed matrix membrane has a thermal effusivity from 8 kWs^{1/2}/m²-K to 12 kWs^{1/2}/m²-K.

Aspect 15. The mixed matrix membrane of any one of claims 9-14, wherein TiN nanoparticles have an average diameter from 10 nm to 500 nm.

Aspect 16. The mixed matrix membrane of any one of claims 9-15, wherein the PVDF has an average molecular weight from 250,000 g/mol to 1,500,000 g/mol.

Aspect 17. A solar-driven surface heating membrane distillation system comprising the mixed matrix membrane of any one of claims 9-16 separating a feed side and a collection portion of a membrane distillation module.

Aspect 18. A method comprising: casting a dope solution onto a membrane support template, the dope solution comprising polyvinylidene fluoride (PVDF), TiN nanoparticles, and a solvent; immersing the cast dope solution on the membrane support template into a coagulation bath comprising a nonsolvent; allowing the cast dope solution to coagulate in the coagulation bath to form a mixed matrix membrane on the membrane support template, the mixed matrix membrane comprising the PVDF with TiN nanoparticles dispersed therein; and separating the mixed matrix membrane from the membrane support template.

Aspect 19. The method of claim 18, wherein, in the dope solution, the PVDF is present from 5 wt % to 20 wt % and the TiN nanoparticles present from 0.5 wt % to 20 wt %, each by weight of the dope solution.

Aspect 20. The method of claim 18 or 19, wherein the dope solution is cast to a thickness from 0.2 mm to 1 mm, and wherein the membrane has a thickness from 0.1 mm to 0.5 mm.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art. Indeed, the methods and systems described herein may be embodied in a variety of other forms; furthermore, various omissions, substitutions, and changes in the form of the methods and systems described herein may be made without departing from the spirit of the present disclosure. The accompanying claims and their equivalents are intended to cover such forms or modifications as would fall within the scope and spirit of the present disclosure.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and all three of A and B and C.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for case of explanation only and are not meant to be limiting.

### Examples

TiN-incorporated mixed matrix membranes (TIN-MMMs) were fabricated using a nonsolvent-induced-phase-separation method with PVDF as the polymeric matrix, dimethylacetamide DMAC as the solvent, and TiN as the plasmonic nanoparticles. PVDF was first dissolved in DMAC at a concentration of 10 wt % and continuously mixed for about 8 hours.

A clear homogenous solution was observed. Then, the TiN nanoparticles were added to the polymer solution at concentrations of 2 wt %, 4 wt %, 8 wt %, or 10 wt %. The mixture was continuously stirred for about 24 hours. The resulting dope solution was then cast onto a DMAC-wetted commercial non-woven polypropylene membrane support affixed on a glass casting plate using an adjustable casting knife at 500 μm thickness. After the formation of a smooth layer of the TiN/PVDF membrane was observed, the glass plates were immersed in a coagulation bath of deionized water for about 1-2 hours. The membranes were then washed with deionized water to remove any polymer or solvent residuals and dried at room temperature inside the fume hood for about 24 hours. MMM-TiN2, MMM-TIN4, MMM-TiN8, and MMM-TiN10 refer to the TIN-MMMs prepared using dope solutions respectively having 2 wt %, 4 wt %, 8 wt %, and 10 wt % of TiN nanoparticles.

A control MMM was prepared using the foregoing procedure with 0 wt % TiN nanoparticles in the dope solution.

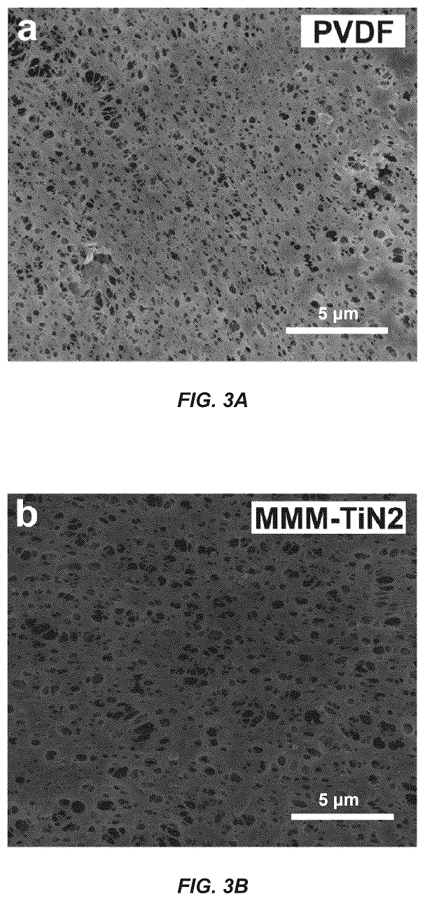

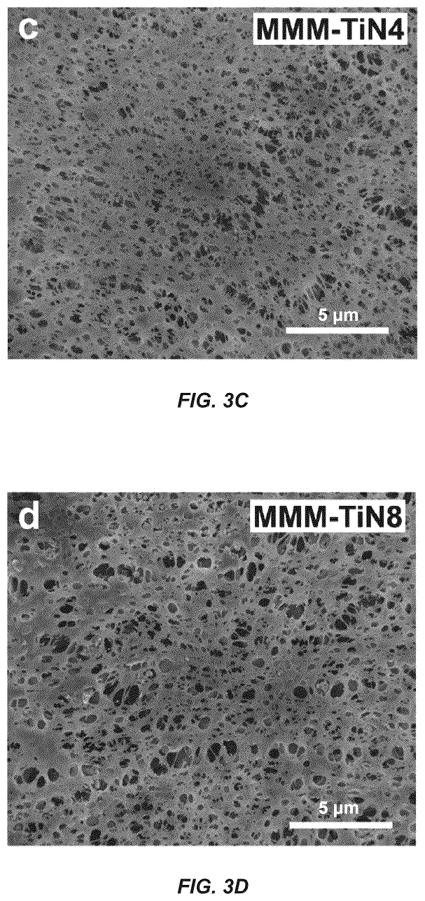

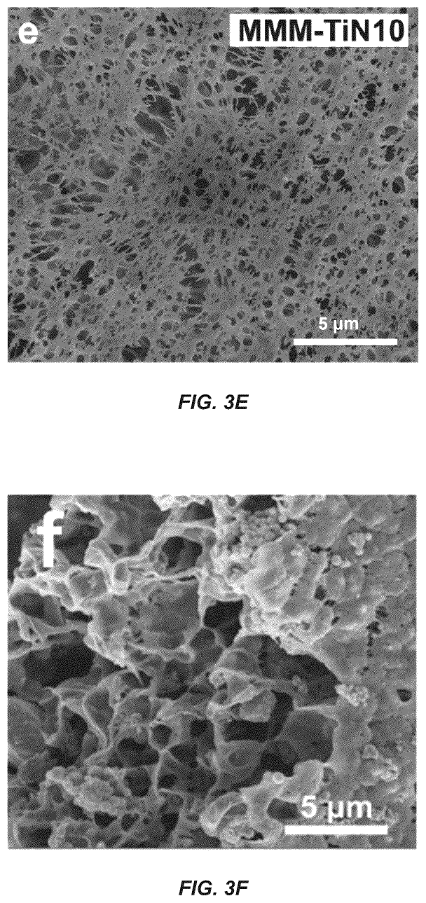

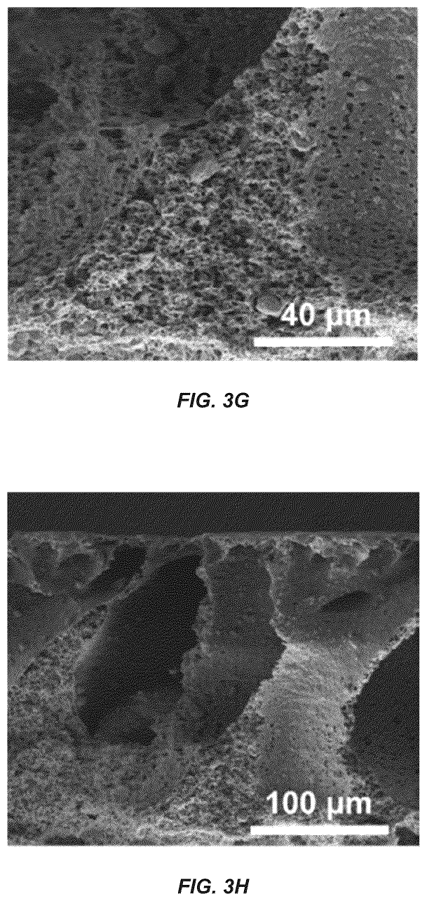

The fabricated membranes had a sponge-like porous structure. FIGS. 3A-3E are top-down scanning electron microscopy (SEM) images of the fabricated membranes-control (FIG. 3A), MMM-TiN2 (FIG. 3B), MMM-TiN4 (FIG. 3C), MMM-TiN8 (FIG. 3D), and MMM-TiN10 (FIG. 3E). FIGS. 3F-3H are cross-sectional SEM images of the MMM-Ti8. Finger-like structures seen in the cross-sectional SEM images may form as a result of rapid solvent/non-solvent exchange during the phase separation process. The membranes manifested a relatively uniform morphology. Nanoparticle agglomerations were not observed at lower concentrations of TiN nanoparticles and were observed sparingly at higher concentrations of TiN nanoparticles.

X-ray diffraction patterns confirmed the crystal structures of TiN nanoparticles in the fabricated TiN-MMMs. Specifically, in each of the fabricated TiN-MMMs, multiple sharp peaks of (111), (200), (220), (311) and (222) were observed respectively at 36.77°, 42.87°, 61.97°, 74.46° and 78.16°. The structural feature is well in agreement with previous reports on TiN nanoparticles. Moreover, the intensity of these peaks was directly proportional to the loading amounts of TiN nanoparticles.

Further, thermogravimetric analysis and EDS analyses confirmed the presence of the TIN nanoparticles in the fabricated TIN-MMMs.

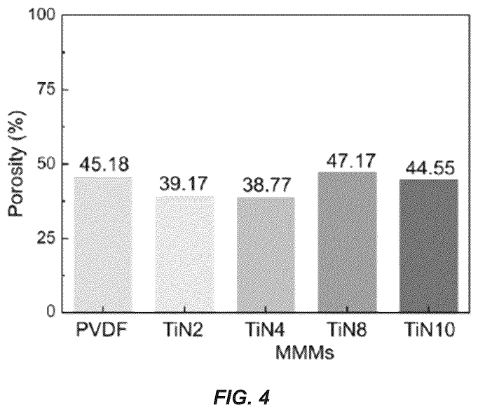

FIG. 4 illustrates a bar graph of the porosity of the fabricated membranes. The addition of TiN nanoparticles did not significantly alter the intrinsic porosity of the control MMM. The porosity of membranes was determined using the gravimetric method. This method involves immersing a membrane sample of known volume using Galwick™ solution (density (ρ_{Galwick}) of 1.79 g/cm³ and surface tension (v) of 15.9 dyne/cm). The sample was allowed to soak in the solution for an adequate duration to ensure that most of the pores were infused with this low-surface tension liquid. Thereafter, masses of the samples before (m₁) and after (m₂) were observed to calculate the porosity using the below equation.

$$Porosity ( \% ) = \frac{{m}_{2} - {m}_{1}}{v {ρ}_{Galwick}}$$

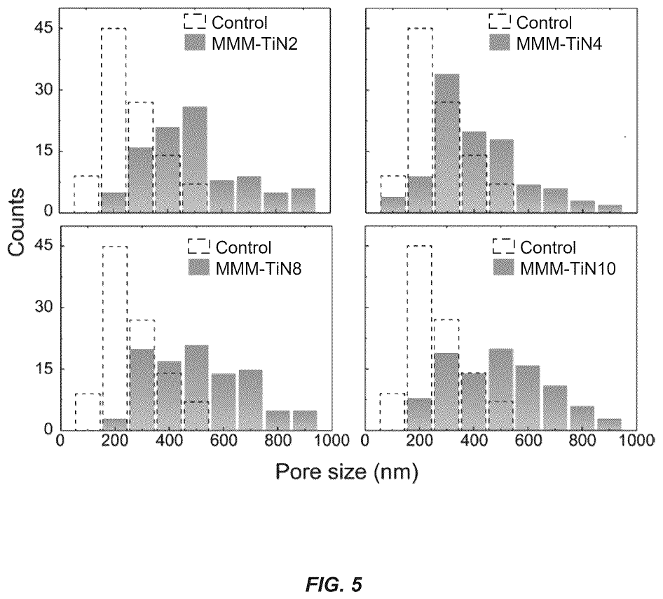

FIG. 5 illustrates comparative bar graphs of the pore size for each of the TiN-MMMs compared to the control MMM (Pristine PVDF—dashed line bars). Interestingly, incorporating TiN nanoparticles into the PVDF membrane led to an increase in the average pore size. The size distribution was interpreted from the top-down SEM images of MMMs. The average pore size broadened from 250 nm to 550 nm. The pore size reached as high as 900 nm when only 2 wt % TiN nanoparticles was included in the dope solution. Notably, MMM-TiN8 and MMM-TiN10 exhibited a dense range of pore sizes, ranging from 200 to 900 nm.

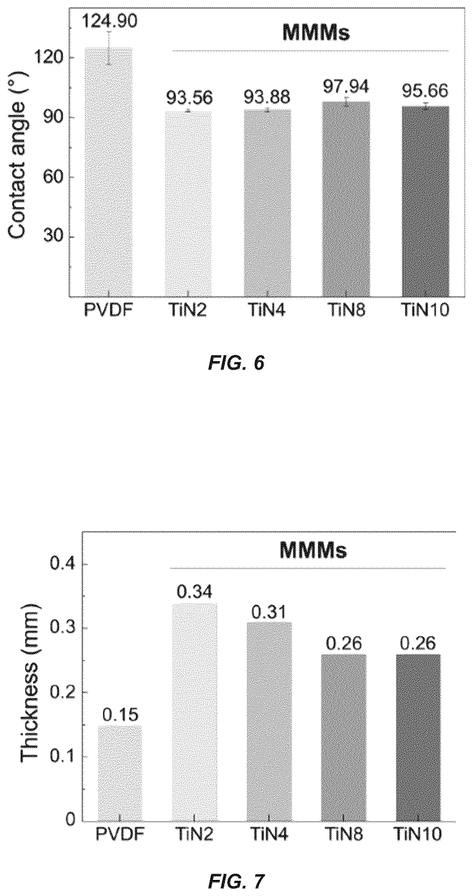

FIG. 6 illustrates a bar graph of the static contact angle of the fabricated membranes measured using deionized water. The PVDF membrane exhibited a contact angle of 124.9° confirming its hydrophobic nature. With the incorporation of TiN NPs into the PVDF matrix, the MMMs overall reduced up to 93.56°. The intrinsic hydrophilic nature (or high surface energy) of TiN nanoparticles may be primarily responsible for this decline in the interfacial hydrophobicity, observed from the TiN-MMMs.

FIG. 7 illustrates a bar graph of the thickness of the fabricated membranes. The addition of TiN nanoparticles may cause a slight increase in the membrane thickness along with the aforementioned change in pore size.

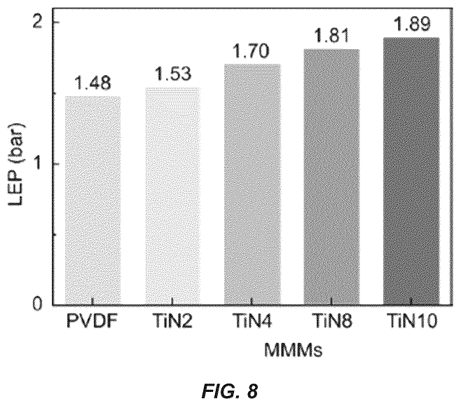

FIG. 8 illustrates a bar graph of the liquid entry pressure (LEP) for the fabricated membranes. Despite the decrease in the hydrophobicity for the TIN-MMMs, the TiN-MMMs exhibited an incremental increase in LEP with increasing TiN loading. The increased LEP may offer more favorable structures for thermal distillation, which in turn promotes higher distillation fluxes.

Leaching of the TiN nanoparticles from the TiN-MMMs was evaluated by observing changes in membrane mass after 24 hours stirring in deionized water at ambient temperature at 400 rpm. The leaching percentage remains consistently below the 0.02% threshold for all the examined TiN-MMMs, indicating that the leaching of TiN nanoparticles is negligible and not of concern. Moreover, to verify the stable incorporation of TiN nanoparticles in the polymeric matrix, the permeate collected after an 8-hour membrane distillation operation was tested using optical absorption for the existence of TiN nanoparticles at 556 nm. The TiN nanoparticles were not detected in a permeate of any of the TiN-MMMs, confirming the strong incorporation and structural stability of TiN nanoparticles within the PVDF matrix.

Table 1 provides mechanical properties for the fabricated membranes. The control MMM displayed the lowest elongation strength, measuring at 16.75 MPa. Typically, fractures occur due to the breakdown or collapse of the PVDF polymeric networks. As described above, the addition of TiN nanoparticles into the PVDF membranes increased the average pore size range and the overall porosity. However, this modification does not appear to have resulted in a reduction in the dynamic entanglement of network chains, but rather may have contributed to an enhancement in the membrane's strength due to high Young's modulus, consequently making said membranes less susceptible to rupture. Therefore, the elongation strength at the breaking point gradually increased with the incorporation of TiN nanoparticles. Specifically, the MMM-TiN8 membrane maintained a tensile stress of 21.71 MPa and an elongation strain of 26.43% at the breaking point.

TABLE 1

| | | Elongation Strain (extension) |
|---|---|---|
| Sample | Tensile Stress (MPa) | (%) |
| Control MMM | 26.70 | 16.75 |
| MMM-TIN2 | 16.70 | 19.78 |
| MMM-TIN4 | 31.02 | 25.37 |
| MMM-TIN8 | 21.71 | 26.43 |
| MMM-TIN10 | 17.90 | 23.43 |

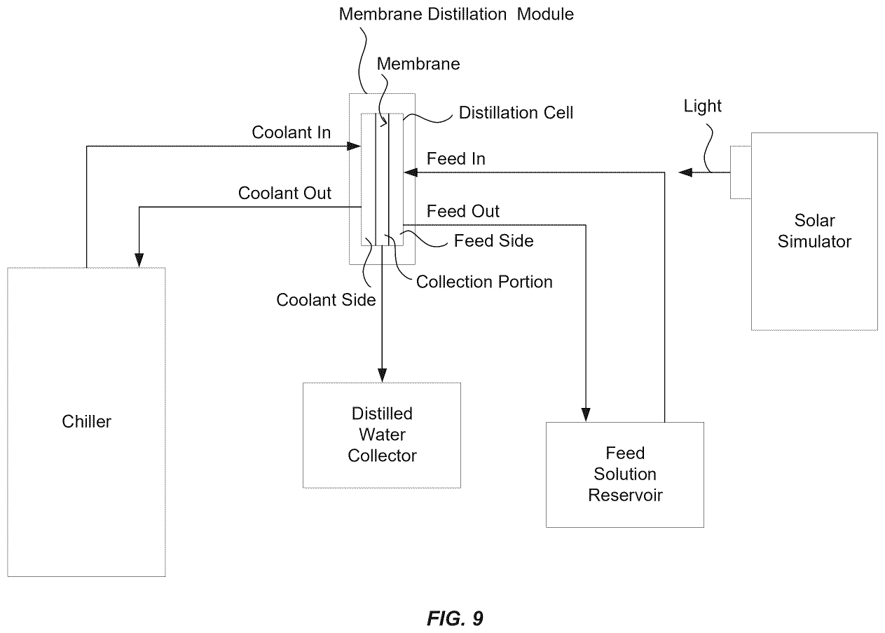

Wastewater treatment performances of the fabricated membranes were experimentally investigated using a solar-driven SHMD setup as depicted in FIG. 9. The system comprises five primary components: a feed loop, a coolant loop, a solar simulator, a membrane distillation module, and a collector. The membrane distillation module is configured to form a cell that is separated into two portions by a membrane to allow for membrane distillation, specifically, solar SHMD, within the cell. The feed loop circulates feed solution through a first portion of the cell. The coolant loop flows coolant (water) through the second portion of the cell. The coolant in these examples was water at about 5° C., unless otherwise noted. The feed solution is maintained in a reservoir at room temperature (about 20° C.) and then heated with light from a solar simulator. In this example, the light intensity from the solar simulator was about 1.25 KW/m², equivalent to 1.25 sun. Due to the scattering of light by the cell, the feed solution is only exposed to a light intensity of about 1 kW/m², which is equivalent to the intensity of sunlight. Both the feed and coolant loops were equipped with thermocouples to monitor and record the feed and coolant temperatures. In this example, temperature measurements were taken every minute for the whole experimental duration, which was about 8 hours. Peristaltic pumps were used to circulate feed solution as well as the coolant through the set-up each at a flowrate of about 200 mL/min, unless otherwise noted.

In a first membrane distillation example, the distillation performance for each of the fabricated membranes was studied using the solar-driven SHMD setup of FIG. 9. A solution of about 120 ppm sodium dodecylbenzene sulfate (SDBS) in water was used as the feed solution, and the total experimental duration was about 8 hours.

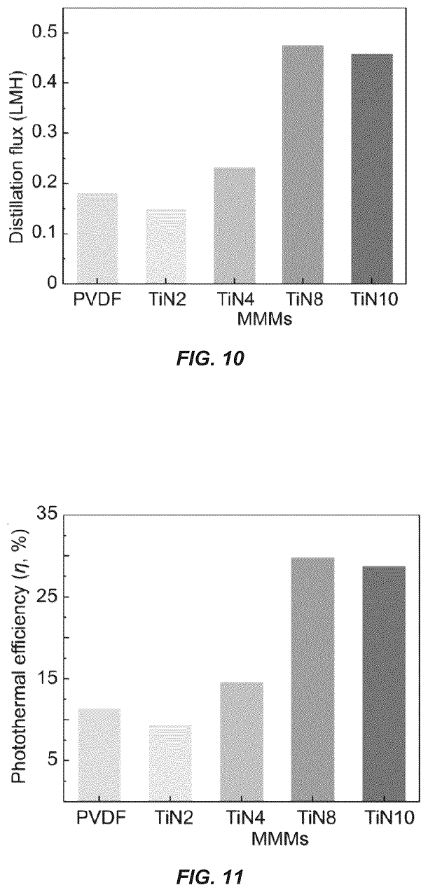

FIG. 10 illustrates a bar graph of the distillation flux (LMH) for each of the fabricated membranes. The control MMM showed an average flux of 0.18 LMH, while incorporating 8 wt % TiN NPs into the membrane matrix yielded an enhanced distillation performance by 161% to a maximum flux of 0.47 LMH. This example illustrates that incorporating TiN nanoparticles in the membrane matrix yielded significant improvement in water permeability compared to bare PVDF membrane. The slight decline in the MMM-TiN2 may be due to the higher fluidic resistance resulting from the increased thickness compared to that of the PVDF membrane and a relatively weaker photothermal heating effect.

To gain further insight into solar-to-thermal conversion and its impact on evaporation, the photothermal efficiency and energy demand of distillation from all the applied MMMs was measured. The photothermal conversion efficiency (n), as shown in below equation, was derived with the aid of dividing the actual flux obtained in each experiment over the maximum theoretical flux.

$$η ( \% ) = \frac{Actual Flux}{Maximum theoretical Flux}$$

Additionally, the energy demand was calculated by dividing solar radiation energy (Qₛₒₗₐᵣ) by the obtained actual flux from each experiment, as demonstrated below equation.

$$Energy demand ( KWh / {m}^{3} ) = \frac{{Q}_{solar}}{Actual flux}$$

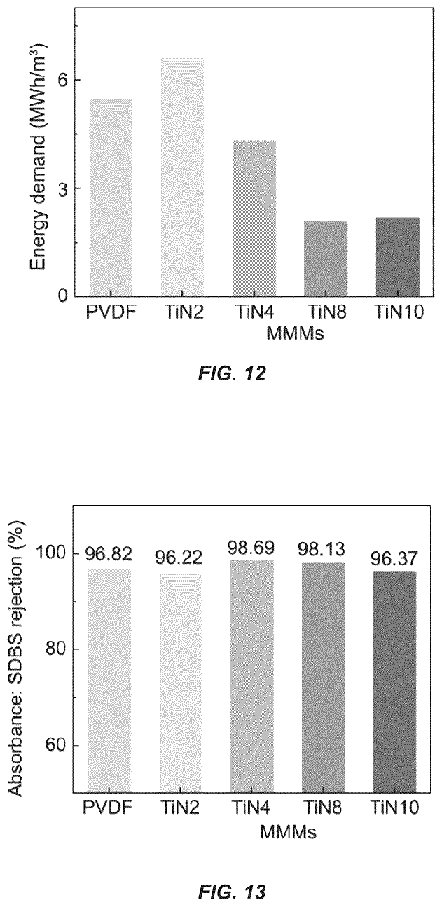

FIG. 11 illustrates a bar graph of the photothermal efficiency for each of the fabricated membranes. FIG. 12 illustrates a bar graph of the energy demand for each of the fabricated membranes. Remarkably, the MMM-TiN8 membrane composition exhibited prominently the highest photothermal efficiency along with the lowest energy consumption. That is, the MMM-TiN8 exhibited the photothermal efficiency of 29.79% while concurrently maintaining the energy demand of 2.11 MWh/m³. In alignment with the trends observed in flux measurements, the incorporation of TiN nanoparticles consistently enhanced photothermal efficiency, while concurrently reducing energy consumption. The reduction in energy consumption, coupled with the elevated photothermal efficiency, suggests that Ti-MMMs have potential for being more sustainable and environmentally friendly membranes for use in membrane distillation operations.

The molecular rejection against the surfactant SDBS across membranes was also investigated. Absorbance measurements (224 nm) were used to measure the concentration of SDBS in the feed and permeate after membrane distillation. FIG. 13 illustrates a bar graph of the percent rejection of SDBS for each of the fabricated membranes. The results revealed that the control MMM had a retention of 96.82%. The addition of TiN nanoparticles did not significantly alter the rejection performance compared to the control MMM.

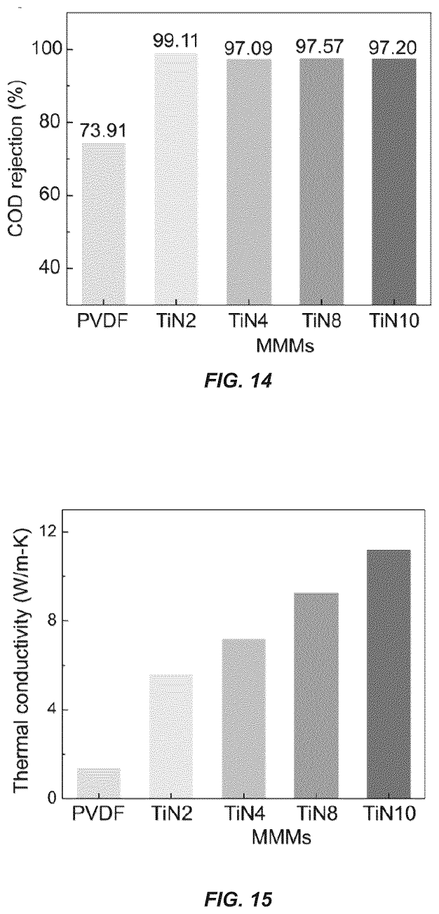

FIG. 14 illustrates a bar graph of the percent rejection of COD for each of the fabricated membranes. The COD amount in ppm verified using a COD reagent kit (HI93754C-25) by inserting the cuvette in a photometer (HI83399, Multiparameter Photometer with COD, Hanna Instruments). Interestingly, all the TiN-MMMs exhibited excellent COD rejection, reaching up to 99%.

The photothermal properties of TiN nanoparticles in the TIN-MMMs were investigated using light absorption measurements. In the wavelength range of 400 nm to 2,000 nm, the MMM-TiN10 showed more than a 4-fold solar absorbance enhancement (overall ˜63% higher absorbance) compared to the control MMM.

There infrared emissivity properties of the fabricated membranes were also examined. Over the infrared spectral range (wavelength from 6 μm to 19 μm), the emissivity values for the fabricated membranes exhibited a consistent range from 0.985 to 0.998, indicating their exceptional thermal radiation-emitting capacity. Notably, the PVDF membranes consistently showcased the highest emissivity values, underscoring their strong thermal radiation-emitting characteristics. Interestingly, the integration of TiN nanoparticles into the PVDF membranes displayed only a marginal reduction in the overall emissivity, signifying that the incorporated TiN nanoparticles did not significantly compromise the thermal performances of PVDF.

As described above, the thermal conductivity and the thermal effusivity of membranes are properties that boost the photothermal efficiency and evaporative effects across membrane surface. FIG. 15 illustrates a bar graph of the thermal conductivity for each of the fabricated membranes. Compared to thermal conductivity (1.39 W/m-K) of the control MMM, the addition of TiN nanoparticles improves the thermal conductivity at least 4-folds (5.65 W/m-K for MMM-TiN2) with higher concentrations of TiN nanoparticles increasing the thermal conductivity (7.20 for MMM-TiN4 and 9.27 W/m-K for MMM-TiN8). The MMM-TiN10 manifested 10-fold greater thermal conductivity (11.63 W/m-K).

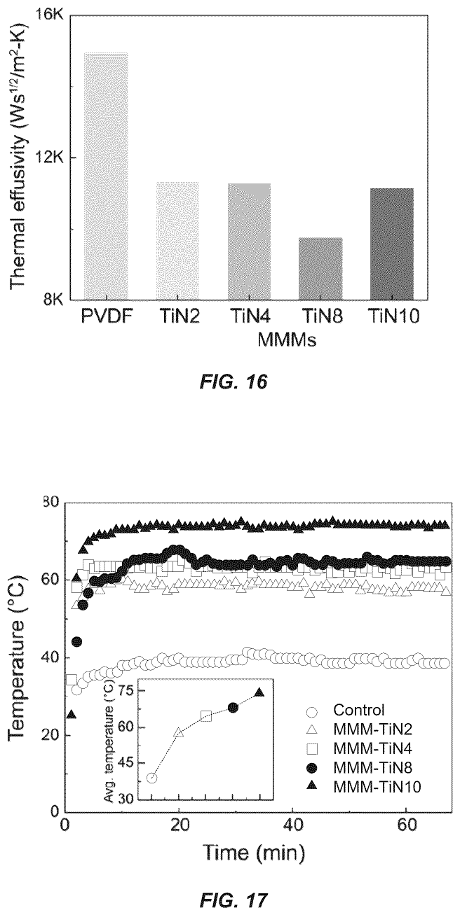

FIG. 16 illustrates a bar graph of the thermal effusivity for each of the fabricated membranes. The control MMM exhibited the highest thermal effusivity at 14.95 kWs^{1/2}/m²-K amongst the fabricated membranes. With the incremental inclusion of TiN nanoparticles, the thermal effusivity of TiN-MMMs showed declining behavior. This may be attributed to the lower thermal effusivity of TiN (8.25 kWs^{1/2}/m²-K). The declining thermal effusivity with increasing TiN nanoparticle concentration strongly supports the enhanced thermal distillation performance in the foregoing membrane distillation example.

The photothermal response of the fabricated membranes under light illumination was investigated by measuring the surface temperature of the fabricated membranes when continuously exposed to 1250 W/m² light intensity at ambient conditions. The membranes were exposed to the air and not in contact with a water or other liquid other than that of ambient conditions. FIG. 17 illustrates a the surface temperature for each of the fabricated membranes over time with an inset graph of the average surface temperature for each of the fabricated membranes over the duration of the experiment. A steady-state sharp increase in the surface temperature was recorded within 10 minutes. The TIN-MMMs showed an incremental increase in the equilibrium temperature with increasing concentration of TiN nanoparticles. Given that the ambient measurement does not entail water evaporation, the increasing trend suggested light-driven surface heating in the presence of TiN nanoparticles. The spontaneous thermal response under sunlight illumination clearly demonstrates excellent photothermal conversion followed by quick thermal conduction throughout the membranes, which is strongly responsible for higher vaporization flux from the membrane surface heating. The resulting photothermal behaviors illustrates that the TiN inclusion in the membrane matrix imparts not only a significant increment of light absorptivity, leading to enhancing the photothermal heating effect but also higher heat transfer across membranes compared to the control MMM.

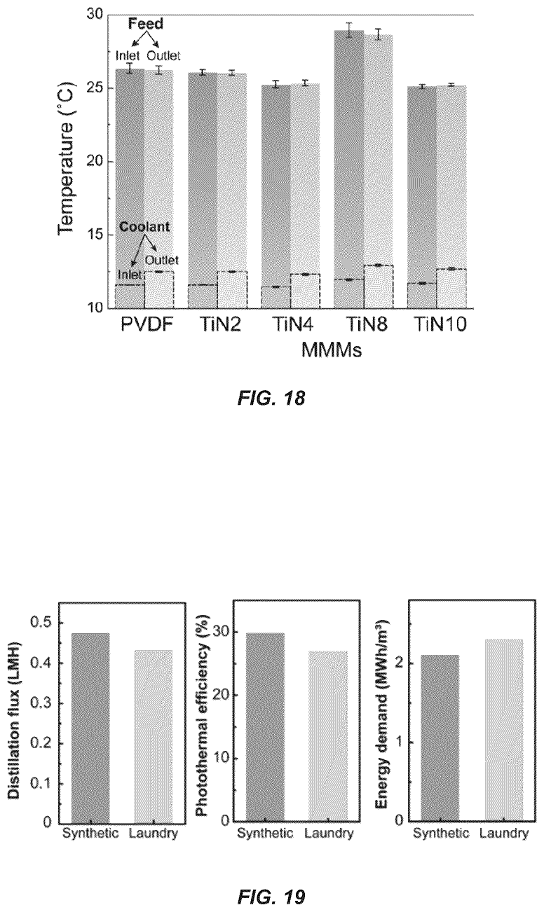

Returning to the membrane distillation example above, the temperature of the feed solution and the coolant were monitored. FIG. 18 is a bar graph of the feed solution temperature at the corresponding inlet and outlet of the cell overlaid with the coolant temperature at the corresponding inlet and outlet of the cell for each of the fabricated membranes. The temperature of the feed outlet exhibited only a small change, compared to that of the feed inlet, across all the operations. The coolant temperature was higher at the outlets than at the inlets. This may be primarily caused by the latent heat released when water vapor condenses on the coolant pad (a thermally highly conductive metallic pad that induces vapor condensation inside the cell). The discernible disparity between the observed water flux (FIG. 10) and the thermal response of the feed as a whole (FIG. 18) implies that the thermal heating of the feed by the membrane is highly localized and effectively utilized for vaporization at the interface between the membrane and the feed. That is, the heat generated by exposing the membrane to light is efficiently used for water vaporization and not bulk heating of the feed solution.

In a second membrane distillation example, the distillation performance for the MMM-TiN8 was studied using the solar-driven SHMD setup of FIG. 9. Real laundry wastewater was used as the feed solution, and the total experimental duration was about 8 hours. In general, laundry wastewater has a complex composition that includes a variety of chemical species, including phosphates, calcium, magnesium, potassium, fats, oil, greases, surfactants, and suspended solids.

FIG. 19 illustrates bar graphs of the performance (distillation flux, photothermal efficiency, and energy demand) for the MMM-TiN8 in solar-driven SHMD using the real laundry wastewater or the synthetic laundry wastewater (the SDBS solution in the first membrane distillation example). There was a slightly lower water flux of 0.43 LMH for the real laundry wastewater in comparison to the distillation flux (0.47 LMH) of the synthetic SDBS solution. The MMM-TiN8 with the real laundry wastewater also exhibited a comparable photothermal efficiency of 27.15% compared to the synthetic solution. Further, the results revealed a minor increase in energy demand when testing with the real laundry wastewater (2.31 MWh/m³) compared to the synthetic laundry wastewater (2.11 MWh/m³). Despite the complex composition of the real laundry wastewater, the MMM-TiN8 demonstrated a solar-driven SHMD performance that was quite comparable to the synthetic laundry wastewater.

Additionally, the contaminant rejection rates were analyzed with the comparative analysis of COD levels, total dissolved solids (TDS) levels, and electrical conductivities of the real laundry wastewater before and after distillation provided in Table 2. The solar-driven SHMD with the MMM-TiN8 demonstrated high-performance rejection rates of COD, TDS (an indication of surfactant rejection), and conductivity (an indication of rejection of conductive chemicals like salts).

TABLE 2

| Parameter | Feed | Treated Permeate | Removal Rate (%) |
|---|---|---|---|
| COD (mg/L) | 409 | 62 | 84.8 |
| TDS (g/L) | 3.52 | 0.12 | 96.5 |
| Conductivity (μS/cm) | 3520 | 122 | 96.5 |
| pH | 7.90 | 7.38 | not applicable |

The various features and processes described above may be used independently of one another or may be combined in various ways. All possible combinations and sub-combinations are intended to fall within the scope of the present disclosure. In addition, certain methods or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

All references, including publications, patent applications, and patents, cited herein are hereby incorporated by reference to the same extent as if each reference were individually and specifically indicated to be incorporated by reference and were set forth in its entirety herein.

What is claimed is:

1. A method comprising:
flowing wastewater through a feed side of a membrane distillation module, wherein the feed side is separated from a collection portion of the membrane distillation module by a mixed matrix membrane having a matrix comprising polyvinylidene fluoride (PVDF) with TiN nanoparticles dispersed therein, wherein the mixed matrix membrane has a porosity from 35% to 50%, an average pore size from 250 nm to 550 nm, and a thickness from 0.1 mm to 0.5 mm;
exposing the mixed matrix membrane to sunlight while the wastewater is flowing; and
distilling water across the mixed matrix membrane.

2. The method of claim 1, wherein the wastewater is laundry wastewater.

3. The method of claim 1, wherein the distilled water compared to the wastewater has a chemical oxygen demand removal rate of 80% or greater, a total dissolved solids removal rate of 90% or greater, and a conductivity removal rate of 90% or greater.

4. The method of claim 1, wherein the distilling is characterized by a distillation flux from 0.1 LMH to 0.6 LMH.

5. The method of claim 1, wherein the mixed matrix membrane has a photothermal efficiency from 10% to 35%.

6. The method of claim 1, wherein the wastewater has a temperature at an inlet of the feed side from 20° C. to 45° C.

7. The method of claim 1, wherein a coolant flowing through a coolant side of the membrane distillation module has a temperature at an inlet of the coolant side from 0° C. to 10° C.

8. The method of claim 1 further comprising:
using the distilled water for agricultural irrigation.

9. A mixed matrix membrane comprising:
a matrix comprising polyvinylidene fluoride (PVDF) with TiN nanoparticles dispersed therein, wherein the mixed matrix membrane has a porosity from 35% to 50%, an average pore size from 250 nm to 550 nm, and a thickness from 0.1 mm to 0.5 mm.

10. The mixed matrix membrane of claim 9, wherein a weight ratio of the polyvinylidene fluoride to the TiN nanoparticles is 20:1 to 1:2.

11. The mixed matrix membrane of claim 9, wherein the mixed matrix membrane has a contact angle with deionized water from 90° to 100°.

12. The mixed matrix membrane of claim 9, wherein the mixed matrix membrane has a liquid entry pressure from 1.5 bar to 2 bar.

13. The mixed matrix membrane of claim 9, wherein the mixed matrix membrane has a thermal conductivity from 4 W/m-K to 12 W/m-K.

14. The mixed matrix membrane of claim 9, wherein the mixed matrix membrane has a thermal effusivity from 8 kWs^{1/2}/m²-K to 12 kWs^{1/2}/m²-K.

15. The mixed matrix membrane of claim 9, wherein TiN nanoparticles have an average diameter from 10 nm to 500 nm.

16. The mixed matrix membrane of claim 9, wherein the PVDF has an average molecular weight from 250,000 g/mol to 1,500,000 g/mol.

17. A solar-driven surface heating membrane distillation system comprising the mixed matrix membrane of claim 9 separating a feed side and a collection portion of a membrane distillation module.

18. A method comprising:
casting a dope solution onto a membrane support template, the dope solution comprising polyvinylidene fluoride (PVDF), TiN nanoparticles, and a solvent;
immersing the cast dope solution on the membrane support template into a coagulation bath comprising a nonsolvent;
allowing the cast dope solution to coagulate in the coagulation bath to form a mixed matrix membrane on the membrane support template, the mixed matrix membrane comprising the PVDF with TiN nanoparticles dispersed therein; and
separating the mixed matrix membrane from the membrane support template.

19. The method of claim 18, wherein, in the dope solution, the PVDF is present from wt % to 20 wt % and the TiN nanoparticles present from 0.5 wt % to 20 wt %, each by weight of the dope solution.

20. The method of claim 18, wherein the dope solution is cast to a thickness from 0.2 mm to 1 mm, and wherein the mixed matrix membrane has a thickness from 0.1 mm to 0.5 mm.
